(19) United States
(12) Patent Application Publication
(10) Pub. No.: US 2007/0005935 A1
(43) Pub. Date: Jan. 4, 2007

(54) Method and apparatus for securing and validating paged memory system

(76) Inventors: Hormuzd M. Khosravi, Portland, OR (US); David Durham, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,301

(22) Filed: Jun. 30, 2005

(51) Int. Cl. G06F 12/00

(52) U.S. Cl. 711/216; 711/203

(57) ABSTRACT

A service processor monitors the state of a physical memory and a virtual memory support circuit of a host processor. A second memory, accessible only to the service processor, stores information to permit the service processor to detect changes to pages of the physical memory. Other similar apparatus, and methods to use such apparatus, are described and claimed.

### FIELD OF THE INVENTION

The invention relates to security in virtual memory subsystems. More specifically, the invention relates to validation, integrity verification and tampering detection in paged virtual memory systems with swap capabilities.

### BACKGROUND

Many contemporary microprocessors provide hardware facilities to enable virtual memory implementations, and an operating system (“OS”) will often use those facilities to permit processes to access more memory than may physically exist in the machine, or to support multiple processes, each of which requires a certain amount of memory, when the total amount of memory required by all the processes exceeds the amount of memory installed. One common feature of a virtual memory implementation is “swapping,” where the OS copies a page of a process's memory space to a mass storage device such as a hard disk so that the physical memory that held that page can be reassigned to a different use. If the process later needs to access the “swapped-out” page, the OS obtains a page of physical memory (perhaps by swapping out some other process's data) and restores the data previously copied out to the mass storage device. Virtual memory support hardware allows the OS to place the data in a different physical page than the page that was swapped out. The new page is mapped into the same location in the process's virtual address space, so that the process can continue without needing to detect and account for such page motion.

Memory addressing circuits within a central processing unit (“CPU”) usually provide protection facilities so that the OS can prevent one process from examining or modifying another process's memory. However, when a process's data is swapped out, the CPU's memory protection cannot prevent a malicious process from tampering with the data while it is on the mass storage device. If an altered page is swapped back into memory, the process may be tricked into executing unintended instructions, or operating on incorrect data. To preserve the security and integrity of a program's operations, methods of detecting and preventing such attacks may be desirable.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a block diagram of a computer system that implements an embodiment of the invention.

FIG. 2 is a flow chart indicating operations that may be performed by an operating system swapping data out, then back in, to a page of physical memory.

FIG. 3 is a flow chart of software operating according to an embodiment of the invention.

FIG. 4 shows a multiprocessor system incorporating an embodiment of the invention, with auxiliary components that can be disabled in response to certain situations.

FIG. 5 shows a second multiprocessor system according to an embodiment of the invention.

### DETAILED DESCRIPTION

Embodiments of the invention track an application's code and data when they reside in physical pages of memory in a computer system by calculating a cryptographically secure, one-way hash of each page. If a page is swapped out and subsequently reloaded, the contents of the page will be validated by calculating a second hash value and comparing it with the first hash. If the page has been modified, a tampering alert is raised so that the system can avoid subversion by the modified code or data.

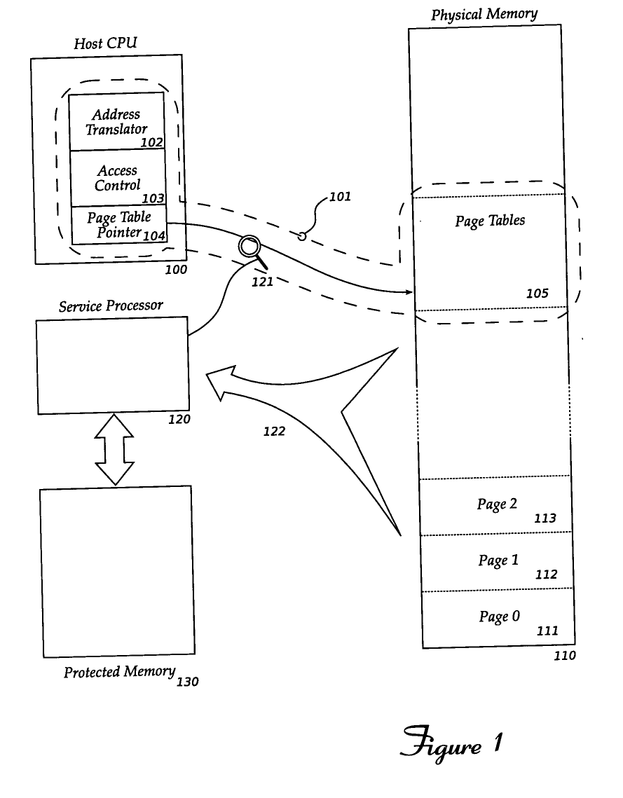

FIG. 1 shows a simplified block diagram of part of a system that implements an embodiment of the invention. Depicted are central processing unit (“CPU”) 100, physical memory 110, service processor 120, and protected memory 130. CPU 100 may be referred to as “Host CPU” when appropriate to clearly distinguish it from the service processor 120.

Physical memory 110 is segmented into units called pages (e.g. 111, 112, 113) that are usually all the same size. The pages of physical memory contain instructions and data of the operating system, device drivers, and application software.

Dashed line 101 surrounds portions of the CPU and physical memory that contain logic circuitry and state information for the CPU's virtual memory (“VM”) support system. Typically, a CPU's VM system will include an address translator 102 to perform virtual-to-physical address translation, an access control unit 103 to enforce access restrictions, and pointer 104 to a portion of physical memory that contains page tables 105. The page tables contain information that is used by the translator 102 to convert a process's virtual address to a page and offset in physical memory, and by the access control unit 103 to specify what physical pages of memory may be read, written and/or executed. Some CPUs might use a multi-level data structure to contain the translation and access control information, so the single page table 105 shown might actually be made up of several distinct blocks of data accessible through pointers or similar mechanisms. Other CPUs might obtain some or all of their VM system configuration information from a different location, distinct from physical memory 110.

Virtual memory systems are involved in most processor accesses to physical memory, so efficient VM operations are important to overall processor and system performance. A practical VM system will almost certainly include additional elements, beyond the typical components outlined above, to improve the system's performance. For example, processors implementing the IA-32 architecture designed by Intel Corporation of Santa Clara, Calif., can be configured to use a one- or two-level data structure (depending on page size) to contain translation and control information. In the single-level configuration, used with 4,194,304-byte (4 MB) pages, the page table pointer 104 (called the “Page Directory Base Register” or “PDBR”), points to a 4,096-byte (4 KB) table containing 1,024, 4-byte entries called Page Directory Entries (“PDEs”). Each PDE contains a number of flags and a pointer to a 4 MB page of physical memory. In the two-level configuration, used with 4 KB pages, the PDBR points to a 4 KB page directory containing 1,024 PDEs, and each PDE points to a 4 KB page table containing 1,024 Page Table Entries (“PTEs”), each of which points to a 4 KB page of physical memory. Each PDE and PTE has a “present” flag to indicate whether the PTE and/or page it points to is valid. The processor will cache recently used page table information in a Page Table Translation Lookaside Buffer (“TLB”) to quickly translate memory accesses to memory locations within the processor's cache. Further details concerning the configuration and operation of the IA-32 virtual memory system may be found in the IA-32 Intel® Architecture Software Developer's Manual, published by the Intel Corporation.

The CPU's VM system mediates access from the CPU to the physical memory and usually controls CPU memory cycles so that an attempt to access (read or write) data at a particular virtual address will be directed to an offset within a certain physical page of memory. The access control unit can also be configured to disallow accesses to certain memory locations, so that a first program can be prevented from examining or modifying a second program's code or data. However, since the CPU can examine and modify its own configuration, such access control may be evaded or defeated by programming errors or malicious software running on the CPU.

The address mapping and access control functions of a CPU's VM system are performed by its hardware according to configuration data stored, for example, in the page tables. These functions provide low-level building blocks that can be combined into a fully-functional multitasking operating environment offering partial or complete isolation between processes. The operating system is usually responsible for employing the CPU's VM support functions and managing one or more configurations to produce a desired program execution environment. Different operating systems may configure the VM support hardware differently even though they may produce similar or identical execution environments. Embodiments of the invention operate at the level of the CPU's VM support hardware and configuration and achieve their results through examination of the hardware and configuration state, so they may be used with any operating system or higher-level software.

Service processor 120 is logically independent from CPU 100, but it need not be physically separated from the CPU as shown in the figure. It may be fabricated on the same die or installed in the same package as the host CPU, and may even share some common circuitry with the CPU, provided that there is a mechanism such as an operating-mode signal by which the operations of the service processor mode can be distinguished from the operations of the CPU. Many IA-32 Architecture processors from Intel Corporation implement a System Management Mode (“SMM”) that has appropriate operational characteristics. SMM illustrates the possibility of using a different processor mode to run instructions separate from the Operating System otherwise in control of the CPU's functions.

The service processor 120 is associated with a protected memory 130, which may contain instructions and data used by the service processor to implement an embodiment of the invention. Memory 130 is called “protected” because it is inaccessible to the host CPU 100. In some embodiments, protection may be enforced by not providing address or data bus connections between host CPU 100 and memory 130. In other embodiments, an operating-mode signal may be used to switch common address and data buses that are shared between the host CPU and the service processor from normal physical memory 110 to protected memory 130. In another embodiment, the contents of the protected memory can be encrypted using a unique key fused into the service processor logic so only it can decrypt the contents therein. In another embodiment, the service processor can be instantiated as a virtual machine to run on the same physical CPU as the applications and data it is protecting. In any embodiment, the contents of memory 130 will be safe from alteration by incorrect or malicious instructions executing on the host CPU. This allows trusted programs to run within the service processor and allows the protection of secrets such as cryptographic keys within the service processor's memory.

This level of protection is different from the “access control,” discussed earlier, that a CPU's VM system can provide for processes executing on the CPU. The latter protection is usually built on execution privilege levels and/or the VM system itself, and can be subverted by a malicious driver or other program exploiting an error or weakness in the OS or a privileged program. Protected memory 130 is actually inaccessible to the host CPU, regardless of the configuration of the CPU's VM system.

The service processor 120 can examine the state of the CPU's VM system as indicated by “looking glass” 121. In the system depicted in FIG. 1, the service processor can observe the state of the address translator 102, access control logic 103, page table pointer 104 and the page tables 105, and furthermore can inspect the contents of physical pages in memory (as indicated by arrow 122). In one embodiment, the service processor can be a bus mastering device with Direct Memory Access (DMA) to the host CPU's physical memory. In another embodiment, the service processor can run as a privileged mode of the host CPU, such as System Management Mode (SMM), that can likewise access all physical memory. Therefore, a program executing on the service processor 120 could reconstruct the virtual address space of a program executing on the host CPU 100, and examine any physical page therein. The service processor 120 may receive a notification signal from the host CPU 100 when a change is made to the VM configuration, or may detect such changes by examining the VM state and comparing it to a previously-observed configuration.

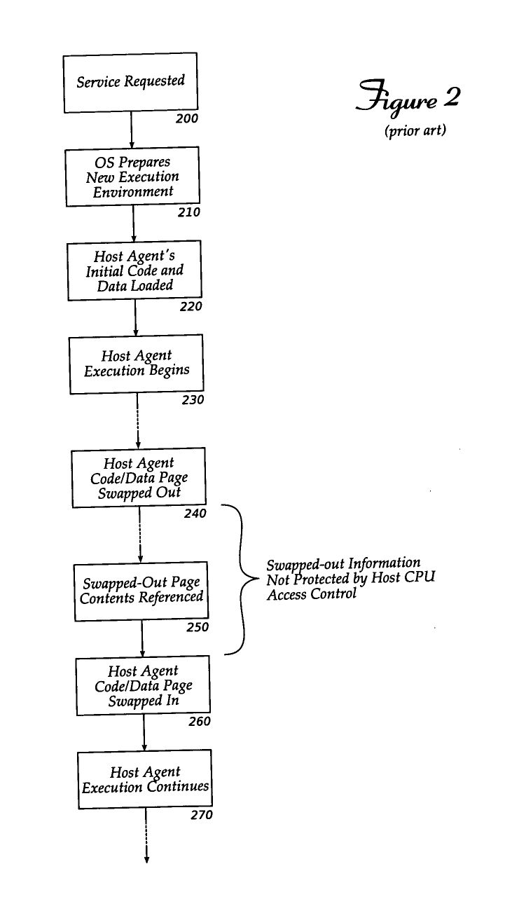

When the computer system is called upon to perform some task, the operating system will typically load a software program into memory and begin executing it. FIG. 2 provides a brief conceptual overview of this process. At 200, some event triggers a request for a service to be provided by a host agent. For example, the system's user may invoke an application program, or a message may arrive over the network to obtain data or service. The operating system prepares a new execution environment for the host agent that is to provide the service (210) and loads the agent's code and initial data into physical pages of memory mapped into the execution environment's virtual address space (220). Then, execution of the host agent can begin (230).

Later, the operating system may require more pages of physical memory than it has available to meet a resource demand, so it may select one of the host agent's pages to swap out (240). The contents of the page will be stored somewhere and the page marked “absent” in the host agent's VM configuration, and the physical page can be re-used for some other purpose. The host agent can continue execution as long as it does not reference data or instructions from the swapped-out page.

Eventually, the host agent may attempt to obtain something from the absent page (250) and trigger a page fault. The OS allocates a page of physical memory, reloads the swapped-out contents, and maps the physical page into the host agent's VM configuration (operations collectively referred to as “swapping in a page” (260)), and the host agent can resume.

Note that during the time between the swap-out operation (240) and the swap-in operation (260), a portion of the host agent's code and/or data is not present in physical memory and cannot be protected by the host CPU's access control hardware. Embodiments of the invention can provide protection for that information during this period of time.

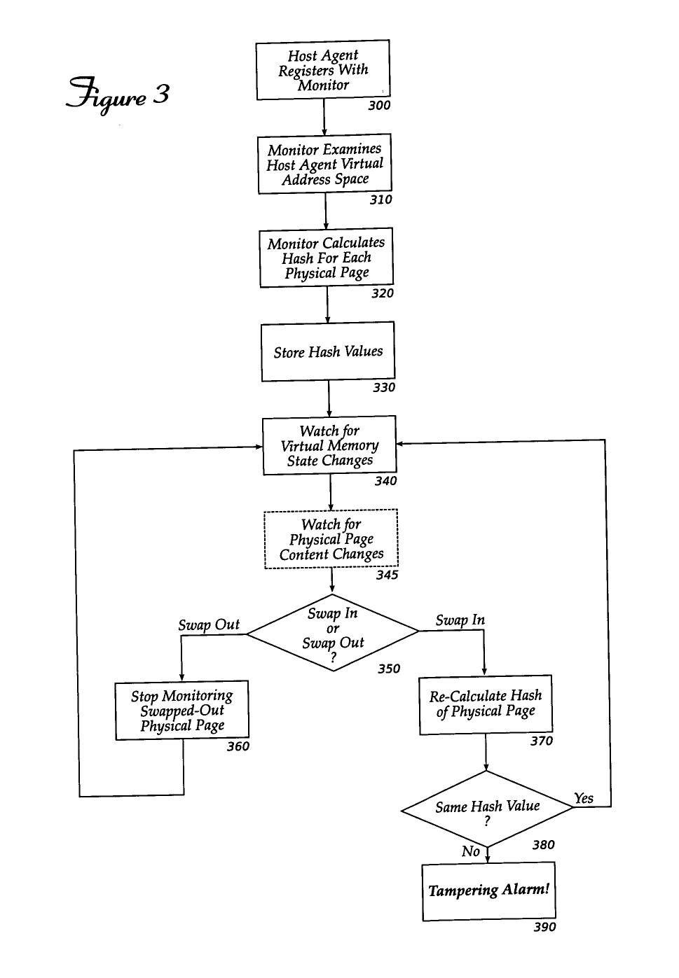

FIG. 3 shows one method by which an embodiment of the invention can detect changes to a host agent's swapped-out code and data. The agent can be any sort of software entity executed by the host CPU, and not only an application program. For example, a driver for a hardware device, or even the operating system itself, could take advantage of the change detection.

Initially, the host agent registers with a Monitor program running on the service processor (300). The Monitor examines the virtual memory state of the host agent's CPU and locates the physical pages that were mapped into the host agent's address space (310). Then, the Monitor calculates a cryptographic hash of the contents of each physical page (320) and stores the hash values in the protected memory (330). Once the hash values are stored, the Monitor watches the host CPU for alterations to its VM state (340). While watching and waiting for VM state changes, the Monitor may passively examine pages to detect data changes caused by errors or malicious programs that evade the CPU's access controls (345).

When a VM state change is detected, the Monitor examines the new VM state and determines whether physical pages have been removed from the host agent's virtual address space (“swapped out”) or added to the virtual address space (“swapped in”) (350). Pages that have been swapped out need no longer be monitored for changes until they are swapped in again (360). Pages that have been swapped in have ostensibly had their contents restored from a source outside the Monitor's purview, so the Monitor re-calculates the hash value for the page (370) and compares it with the previously-stored value (380). If the hash values are the same, the Monitor may resume watching and waiting for VM state changes (340). If the hash values do not match, the Monitor immediately raises an alarm to indicate that the host agent has been altered (390). Unexpected alteration of code or data pages between the time they were swapped out and the time they were reloaded may indicate that a malicious software entity is attempting to tamper with the host agent.

Various refinements to the method outlined with reference to FIG. 3 can be incorporated in embodiments of the invention. For example, the Monitor executing on the service processor could perform its functions either synchronously or asynchronously. When operating synchronously, the service processor would arrest the host CPU so that software executing there would not interfere with the service processor's examination of VM states and physical memory. Once the examination (including, for example, reconstruction of a process's virtual address space, identification of currently-mapped physical pages, and calculation and verification of hash values) was complete, the host CPU would be released and permitted to continue processing.

Synchronous operation can be accomplished using features present in processors produced by Intel Corporation. Virtualization Technology is a set of hardware enhancements to server and client platforms that allows a virtual machine monitor to intercept any interrupt or memory access attempt by the host operating system (or by any instruction sequence executed by an application or other software entity under the control of the host OS). The host CPU is stopped while the virtual machine monitor examines the machine's state to determine whether the intercepted event should be allowed to proceed. If no tampering is detected, the virtual machine monitor

In asynchronous mode, the Monitor would not arrest the host CPU, but would perform its examinations while the host CPU continued its own processing. Asynchronous mode operations would affect host CPU operations less than synchronous mode operations, but would be vulnerable to errors and attacks that altered physical pages before the initial hash value registration was completed or before the hash value of a newly swapped-in page was calculated and checked.

Embodiments of the invention might use any known hash function to detect changes to a host agent's memory pages. Hash values can be calculated by subroutines that are part of the Monitor program, or by dedicated hardware in (or accessible to) the service processor. Examples of useful hash functions include the MD5 message digest, and any of the Secure Hash Algorithms known as SHA-1, SHA-256 and SHA-512. To further increase the reliability of the tampering detection, the Monitor could use a random seed value to perturb the hash calculation. The random seed, stored in protected memory for future use by the service processor and kept secret from the host CPU, would defeat an attack by malicious software that attempted to exploit a hash collision through a carefully-selected modification of a host agent's page.

Some embodiments of the invention may provide additional protection by validating a cryptographic signature or certificate presented by a host agent when the agent registers with the Monitor. This validation could protect against an attack involving a modification of the host agent before its initial registration. The Monitor could validate the signature and examine the certificate chain to ensure that no tampering had occurred before the registration request. Such a signature can be computed by the vendor using a private key. This signature can then be verified as legitimate using the associated public key, or any in a hierarchy of signing keys. The signature can sign information such as the cryptographic hash of the program's image and instructions on how to compute the hash given information on the required fixups and relocatable segments. Validation using signatures or certificates would proceed according to methods known to those of ordinary skill in the relevant arts.

Systems employing embodiments of the invention can respond to a tampering indication from the Monitor running on the service processor in a number of different ways. For example, the service processor could arrest the CPU (if it was not already stopped because the Monitor was operating in synchronous mode), and the Monitor could contact a security administrator via a dedicated communication channel such as a serial or modem line, or via the system's own network interface. Alternatively, the service processor could issue an interrupt or other similar signal to cause the operating system to begin special lockdown procedures. As yet another possibility, the service processor could disable selected system components such as mass storage interfaces or network interfaces. By disabling a mass storage interface, an embodiment of the invention may be able to prevent a possible malicious software entity from damaging stored data. Disabling or disconnecting a network interface may keep the malicious program from transmitting itself to other connected machines.

Embodiments of the invention can be used with systems containing multiple host CPUs. The multiple CPUs may be located in separate physical packages, or may be formed as independent “cores” in a single package. (Multi-core CPUs may share certain circuitry such as cache memory, address and data interface circuits, and/or VM support circuits.) Alternatively, a system may contain a combination of single-core and multi-core CPUs. There may be only one support processor for the entire multiprocessor system, or there may be a separate support processor for each single-core or multi-core CPU.

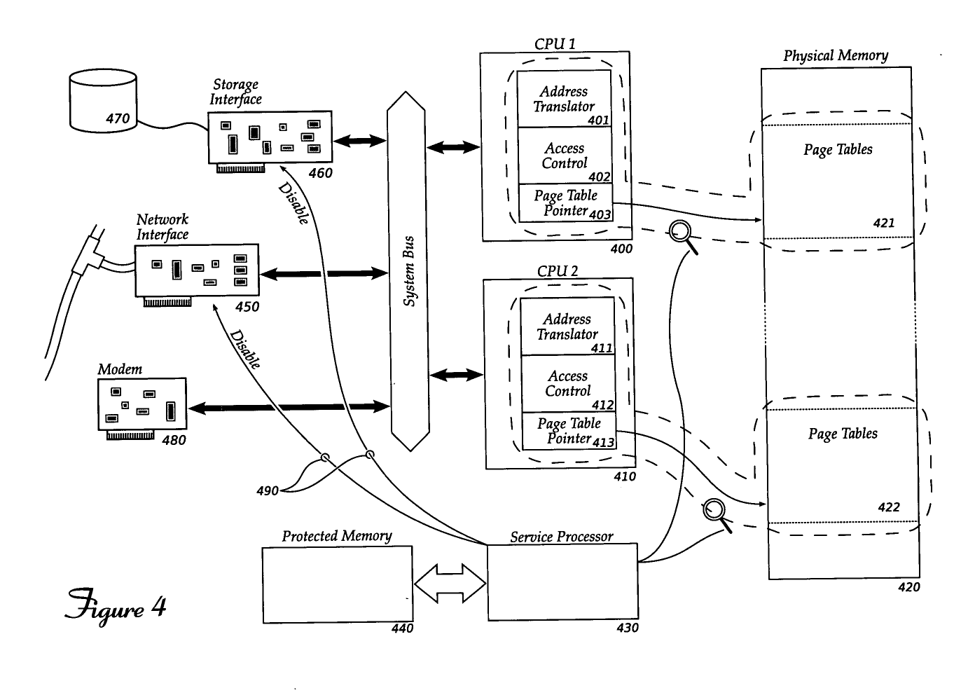

FIG. 4 shows a multiprocessor system incorporating components to implement an embodiment of the invention. CPUs 400 and 410 each contain virtual memory support circuitry (address translation logic 401, 411; access control circuits 402, 412; and page table pointers 403, 413) and refer to state information in physical memory 420 (page tables 421, 422). Service processor 430 can monitor the state of each CPU's VM system, can examine pages of physical memory 420, and can calculate and securely store anti-tamper information such as hash values of pages of physical memory in protected memory 440. The system also contains hardware devices such as network interface 450, storage interface 460 connected to hard disk 470, and modem 480. Service processor 430 can disable selected hardware devices via control lines 490 to prevent a possible malicious software entity from causing more damage after tampering is detected in some host agent that is registered with the service processor. The service processor can also suspend or halt the execution of the host CPU or otherwise cause the system to sleep, reboot, shutdown or otherwise incapacitate the host.

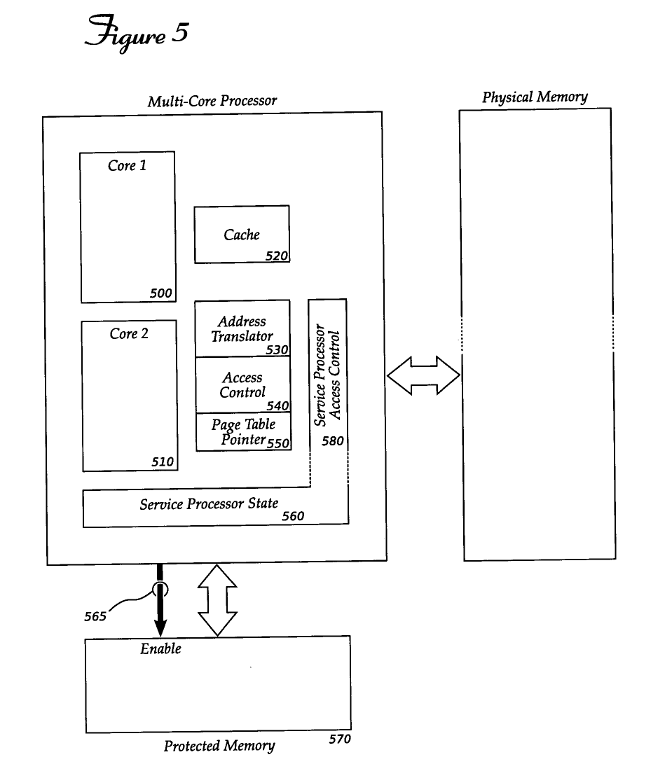

FIG. 5 shows another multiprocessor system including components to support an embodiment of the invention. CPUs 500 and 510 are multiple cores of a single processor; they share circuitry such as cache 520, address translation logic 530, access control 540 and page table pointer 550. In this system, the functions of the service processor are performed by one of the cores, operating under control of separate service processor state information 560. A service processor mode signal 565 is used to enable access to protected memory 570. When the CPU's cores are not executing service processor functions, access to the protected memory is disallowed. In this embodiment, the service processor is provided with its own physical page access control mechanism 580 that cannot be reconfigured by the host CPUs. The second access control logic permits the service processor to control the host CPUs' accesses to physical pages it is monitoring, thus providing an opportunity for the service processor to validate the contents of those pages before instructions executing on the host CPUs are permitted to access the pages. The access control mechanism is transparent to the host CPUs in the sense that if a host CPU attempts to access physical memory in a way that is disallowed, the service processor will intervene to ensure that the host CPU does not operate on tainted instructions or data, but then allow the host CPU to continue (or raise an alarm if tampering is detected).

In any of the previously-described embodiments, if the service processor runs out of protected memory for the page hashes, it is also possible that it can store the page hashes on external mass media. The page table information and hashes can be secured on such media using cryptographic functions as secrets stored in protected memory. This allows the service processor to validate any amount of virtual information that can be accommodated by the host, and not just the amount of information for which cryptographic hashes can be stored in the protected memory.

Embodiments of the invention may take the form of software to execute on the service processor to provide tamper detection as described. Since the operations are performed by a separate processor (or at least a separate logical processing environment) from the CPU(s) that execute the operating system and host agent software, and rely only on information that can be gathered from the observable state of the host CPUs' virtual memory support hardware and configuration, embodiments of the invention can be used with any operating system, regardless of the OS's specific implementation of multitasking and virtual memory. Examples of operating systems that implement virtual memory subsystems compatible with embodiments of the invention include versions of Windows™ from Microsoft Corporation of Redmond, Washington, Mac OS X from Apple Computer, Incorporated, of Cupertino, Calif., and Linux™, an operating system developed by many loosely-affiliated software engineers.

When the invention is embodied in software, it may be placed on a machine-readable medium such as Compact Disc Read-Only Memory (CD-ROM), Read-Only Memory (ROM), Random Access Memory (RAM), Erasable Programmable Read-Only Memory (EPROM), or encoded for transmission over a network such as the Internet. Other machine-readable media can also contain such a software embodiment.

The applications of the present invention have been described largely by reference to specific examples and in terms of particular allocations of functionality to certain hardware and/or software components. However, those of skill in the art will recognize that virtual memory tamper detection can also be produced by software and hardware that distribute the functions of embodiments of this invention differently than herein described. Such variations and implementations are understood to be apprehended according to the following claims.

We claim:

1. An apparatus comprising:
at least one host processor;
at least one virtual memory support circuit;
a service processor to monitor a state of the at least one virtual memory support circuit;
a first memory accessible to every host processor and to the service processor; and
a second memory accessible to the service processor only.

2. The apparatus of claim 1, further comprising:
access control logic to control access from the at least one host processor to the first memory, wherein the access control logic is separate and distinct from the virtual memory support circuit, and wherein the access control logic is inaccessible and transparent to the at least one host processor.

3. The apparatus of claim 1, further comprising:
a machine-readable medium containing instructions to cause the service processor to perform operations including:
calculating a first hash of a first physical page of the first memory;
storing the first hash in the second memory;
detecting a change of the state of the at least one virtual memory support circuit;
calculating a second hash of a second physical page of the first memory;
comparing the second hash to the first hash; and
if the first hash is not equal to the second hash, producing an alarm signal.

4. The apparatus of claim 1, further comprising:
a mass storage device to store a hash value calculated by the service processor.

5. The apparatus of claim 1, further comprising:
a signal generator to generate a signal to disable one of a network interface and a mass storage interface.

6. An apparatus comprising:
a first processor;
a second processor;
a first means for mediating access from the first processor to a memory according to a configuration;
authentication means for computing a hash of a portion of the memory;
protected storage means for recording the hash so that it cannot be accessed by the first processor;
confirmation means for comparing the hash of the portion of the memory to a previously-computed hash of the portion of the memory; and
alarm means for signaling a failed confirmation.

7. The apparatus of claim 6, further comprising:
a second, independent means for controlling access from the first processor to a memory, the second means protected against reconfiguration by the first processor.

8. The apparatus of claim 6 wherein the alarm means comprises:
an interrupt means for disabling the first processor.

9. The apparatus of claim 6 wherein the alarm means comprises:
a network disconnector for disabling a network interface.

10. A method comprising:
calculating a first hash value of a memory page;
monitoring an association between a virtual memory address and the memory page;
if the association between the virtual memory address and the memory page changes, calculating a second hash value of the memory page and
issuing a tampering alert if the first hash value differs from the second hash value.

11. The method of claim 10, further comprising:
arresting a processor if the association between the virtual memory address and the memory page changes; and
releasing the processor if the first hash value equals the second hash value.

12. The method of claim 10 wherein issuing a tampering alert comprises:
disabling at least one of a mass storage interface and a network interface.

13. The method of claim 10 wherein issuing a tampering alert comprises:
contacting a security administrator through one of a modem connection and a network connection.

14. The method of claim 10 wherein issuing a tampering alert comprises:
causing a processor to enter one of a halt, suspend, sleep, and shutdown state.

15. The method of claim 10 wherein calculating a first hash value comprises:
computing one of a MD5 message digest, a SHA-1 hash, a SHA-256 hash, and a SHA-512 hash over a contents of a memory page.

16. The method of claim 15 wherein calculating a first hash value further comprises:
using a random seed value to perturb a hash calculation.

17. A method comprising:
registering a first physical page that is mapped at a virtual address of a host agent; and
if a second physical page is mapped at the virtual address of the host agent, verifying the second physical page; and
if a contents of the second physical page differs from a contents of the first physical page, signaling a possible tampering condition.

18. The method of claim 17 wherein registering comprises:
calculating a hash of the contents of the first physical page; and
storing the hash in a protected memory.

19. The method of claim 17 wherein registering comprises:
validating a cryptographic signature of the host agent.

20. The method of claim 17 wherein the first physical page is different from the second physical page.

21. The method of claim 17 wherein registering comprises:
calculating a hash of the contents of the first physical page; and
storing the hash on a mass media device.

22. A system comprising:
a service processor;
a plurality of host processors;
a first memory that is accessible to the service processor and to the plurality of host processors;
a second memory that is accessible to the service processor and inaccessible to the plurality of host processors; and
an operating system; wherein the service processor is to calculate a first hash of a page of the first memory; and
if a state of a virtual memory map is changed, the service processor calculates a second hash of the page of the first memory.

23. The system of claim 22, further comprising:
a network interface; wherein if the first hash is not equal to the second hash, the service processor disables the network interface.

24. The system of claim 22, further comprising:
a communication device; wherein
if the first hash is not equal to the second hash, the service processor contacts a security administrator using the communication device.

25. The system of claim 22, further comprising:
a mass storage device; wherein
the operating system is to load data from the mass storage device into a swap-in page of the first memory; and
the service processor is to calculate a hash of the swap-in page.

26. The system of claim 22 wherein the operating system is one of Windows, Mac OS X, and Linux.

27. A machine-readable medium containing instructions that, when executed by a service processor, cause the service processor to perform operations comprising:
reconstructing a state of a virtual memory support system;
calculating a first hash of a contents of a first physical page that is mapped by the virtual memory support system;
monitoring the virtual memory support system for changes to a mapping; and
calculating a second hash of a contents of a second physical page that is mapped by the virtual memory support system.

28. The machine-readable medium of claim 27, containing additional instructions that, when executed by the service processor, cause the service processor to perform further operations comprising:
verifying a cryptographic signature of a portion of memory.

29. The machine-readable medium of claim 27 wherein the first physical page is different than the second physical page; and
the first physical page and the second physical page are mapped at the same virtual address.

30. The machine-readable medium of claim 27 wherein calculating a first hash of a contents of a first physical page comprises:
perturbing a hash calculation with a random seed value; and
calculating one of a MD5 message digest, a SHA-1 hash, a SHA-256 hash, and a SHA-512 hash.
